(19) United States
(12) Patent Application Publication
(10) Pub. No.: US 2026/0322227 A1
(43) Pub. Date: Oct. 15, 2026

(54) METHOD OF MANUFACTURING A HIGH DENSITY MOTOR

(71) Applicant: FLANDERS ELECTRIC MOTOR SERVICE, LLC, Evansville, IN (US)

(72) Inventors: Vadim SHCHERBAKOV, Ljubljana (RU); Brian Curtis Havens, Colombia, SC (US); Dan Schenk, Evansville, IN (US); Aseem Kumar Routray, Evansville, IN (US)

(73) Assignee: FLANDERS ELECTRIC MOTOR SERVICE, LLC, Evansville, IN (US)

(21) Appl. No.: 19/177,430

(22) Filed: Apr. 11, 2025

(51) Int. Cl. H02K 15/40; H02K 5/20; H02K 9/193; H02K 21/16

(52) U.S. Cl. CPC H02K 15/40; H02K 5/203; H02K 9/193; H02K 21/16

(57) ABSTRACT

A method includes manufacturing stator segments according to a subprocess. The subprocess includes pressing grain oriented steel (GOES) sheets into a block, removing a portion of the GOES to shape the block into an arcs of a circle to form stator segments, forming a lock in a first end of the arcs of the stator segments, forming a lock receiver at a second end of the arcs of the stator segments, and forming stator teeth insets on an interior surface of the arc of the stator segment. The method also includes manufacturing stator teeth of the GOES that are oriented along axes of the stator teeth, and wrapping electrical windings around the stator teeth. The method also includes manufacturing a stator by connecting the stator segments via the lock and the lock receiver of each of the stator segments, and by connecting the stator teeth to the stator teeth insets.

### BACKGROUND

Electric motors may be designed to convert electrical energy to torque (force through an angle), and vice versa, depending a mode of operation of the motor. For example, in one mode of operation, an electric motor may receive electrical energy from a source (e.g., a battery or other supply) and convert the electrical energy into torque, which in turn forces a drive shaft to rotate. The rotating drive shaft may then be used to drive an axle, which in turn drives the wheels of a vehicle. However, in another mode of operation, the electric motor instead may be driven by the drive shaft. For example, the wheels of a vehicle may turn an axle, which turns the drive shaft of the motor. In this case, the motor generates electricity by converting the torque applied to the motor into electricity. The generated electricity then may be stored or used.

In general, the larger the motor, the more electricity the motor can use or generate. Thus, if a new motor is to generate more electricity than an older motor, a larger motor may be built.

However, for some applications, the size of the motor is constrained. Nevertheless, the same applications may call for generating or using more electricity than a conventional motor can generate or use within the size constraint.

An example of such an application is a hybrid haul truck (i.e., a haul truck that uses a combination of an internal combustion engine, an electric motor, and a battery to drive the haul truck). A haul truck is a type of large dump truck used in industrial mining operations. Haul trucks may be larger than some buildings. Thus, the drive system of a haul truck has a very high torque requirement, and therefore a very high electrical power requirement, relative to most other vehicles. Despite the size of the haul truck, there may not be sufficient space in the haul truck for a motor powerful enough to meet the desired torque and power generation specifications for haul truck operation. Thus, new motor designs are sought which have the desired torque and electrical energy generation specifications, while remaining within the size limitations imposed by use of the motor in the haul truck.

### SUMMARY

One or more embodiments provide for a method of manufacturing. The method includes manufacturing a number of stator segments. Manufacturing each of the stator segments includes a subprocess. The subprocess includes pressing a number of sheets into a block. Each of the sheets includes a grain oriented steel. The subprocess also includes removing a portion of the grain-oriented steel to shape the block into an arc of a circle. The arc includes a stator segment among the stator segments. The subprocess also includes forming a lock in a first end of the arc of the stator segment. The subprocess also includes forming a lock receiver at a second end of the arc of the stator segment, opposite the first end. The subprocess also includes forming a number of stator teeth insets on an interior surface of the arc of the stator segment. The method also includes manufacturing a number of stator teeth of the grain oriented steel that are oriented along axes of the stator teeth, forming a number of stator tooth extensions extending from the stator teeth, and wrapping a number of electrical windings around the stator teeth. The method also includes manufacturing a stator by connecting the stator segments via the lock and the lock receiver of each of the stator segments, and by connecting the stator teeth to the stator teeth insets of the stator segments.

Other aspects of the one or more embodiments will be apparent from the following description and the appended claims.

### BRIEF DESCRIPTION OF DRAWINGS

FIG. 1, FIG. 2, FIG. 3, FIG. 4, FIG. 5, FIG. 6, and FIG. 7 show different views of an electric motor, in accordance with one or more embodiments.

FIG. 8 shows a flowchart of a method of manufacturing the electric motor of FIG. 1 through FIG. 7, in accordance with one or more embodiments.

Like elements in the various figures are denoted by like reference numerals for consistency.

### DETAILED DESCRIPTION

One or more embodiments are directed to electric motors having improved performance densities. One measure of performance density is a ratio between the peak electrical energy the motor can generate and the size of the electric motor. Another measure of performance density is a ratio between the peak torque the motor can generate and the size of the electric motor. In either case, the smaller the size of the motor for the same performance metric (peak electrical energy generated or peak torque), the better the performance density or performance densities of the electric motor.

One or more embodiments provide for improved performance densities over conventional motors. In particular, one or more embodiments provide for electric motors designed to maximize the magnetic flux passed through the windings inside the electric motor, leading to improved electricity generation.

Formally, magnetic flux is the surface integral of the normal component of a magnetic field over a surface. Stated differently, magnetic flux is a measure of the total magnetic field which passes through a given surface. The magnetic flux depends on three factors: the area of the surface, the strength of the magnetic field in which the surface is located, and the angle between the surface and the magnetic field.

In one or more embodiments, the “surface” is the electrically conductive windings disposed within the electric motor. When the windings move through the changing magnetic fields of rotor magnets, due to the rotation of the rotor, electricity is generated in the windings (in electricity generation mode). When electricity is supplied to the windings. The change in current induces a magnetic field, which interacts with the rotor magnets, thereby forcing the rotor to spin (in torque generation mode).

An electric motor of one or more embodiments is designed to improve the magnetic flux through to the windings by increasing the strength of the magnetic field at the electrically conductive windings, relative to conventional electric motors. In particular, one or more embodiments include a method of manufacturing the motor to use grain oriented steel (GOES) for the stator, the rotor, and the stator teeth that increase the magnetic flux through those components. The particular arrangement of GOES components allows the stator teeth and the stator itself to operate in a linear B_H curve region of the GOES components, instead of entering the saturation region of the B-H curve region of the GOES components. Thus, the total magnetic flux passing through the stator and stator teeth is increased, thereby increasing the magnetic flux through windings in the rotor.

In addition, a GOES material is used to form rotor teeth to hold permanent magnets in place, thereby not only holding the magnets in place but also providing an easier path for the magnetic flux from the magnets to interact with the stator and stator teeth. Thus, the magnetic flux is further increased, and hence more electricity (or torque) can be generated by the motor.

Additionally, the motor includes a jacketed liquid cooling system disposed directly against the stator. The liquid cooling system efficiently removes heat from the motor, thereby increasing the electrical performance of the motor. Removing heat reduces an undesirable increase in electrical resistance in the windings caused by an increase in temperature in the windings. Removing heat also reduces an undesirable increase in magnetic flux resistance that occurs with increasing temperature of the motor components. Removing heat also reduces insulation degradation in the motor (for components that include insulation) thereby increasing the life of the motor. Removing heat also may help prevent demagnetization of the magnets located in the rotor, again improving motor life.

Still further, the stator windings use rectangular copper wire to maximize the fill factor around the stator teeth. The fill factor is a ratio of the area consumed by the windings in a stator slot to the total available area of the stator slot. Maximizing the fill factor further increases the amount of magnetic flux through the windings.

Yet further, the arrangement of joints that form the stator help the motor to be more compact, relative to other motors. In particular, one or more embodiments provide for a houseless motor in which the outer circumference of the stator is the outside surface of the motor. The houseless design is accomplished using stator connected to each other via dovetail locks. When provided, the liquid cooling jacket may be placed outside the stator, thereby providing direct cooling to the stator of the motor. Eliminating the motor housing further reduces the size of the motor.

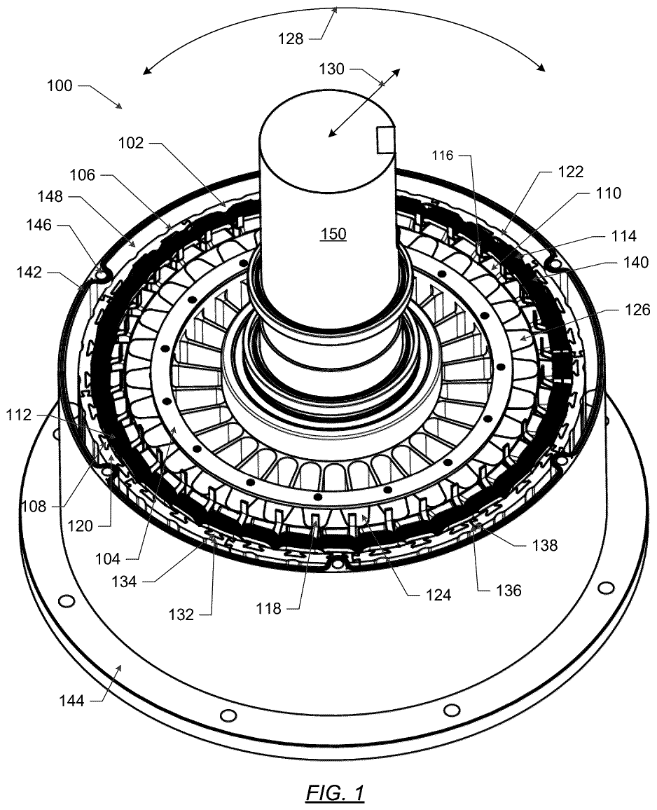

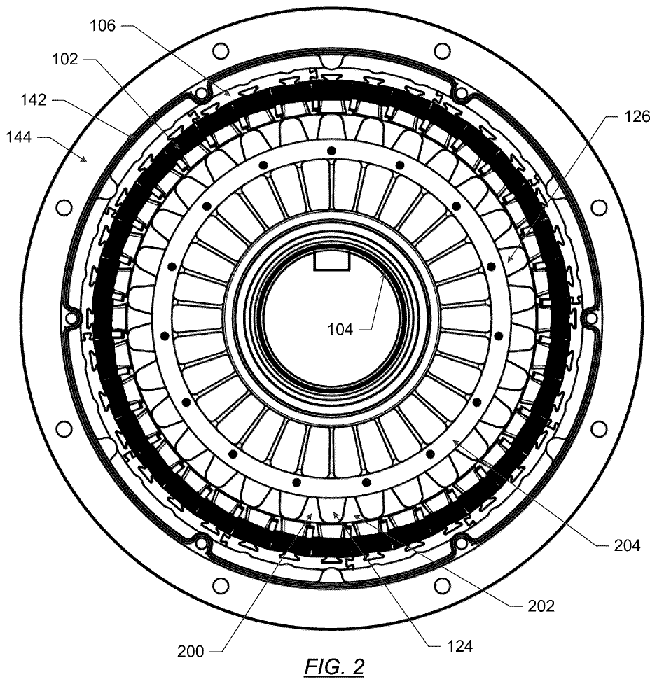

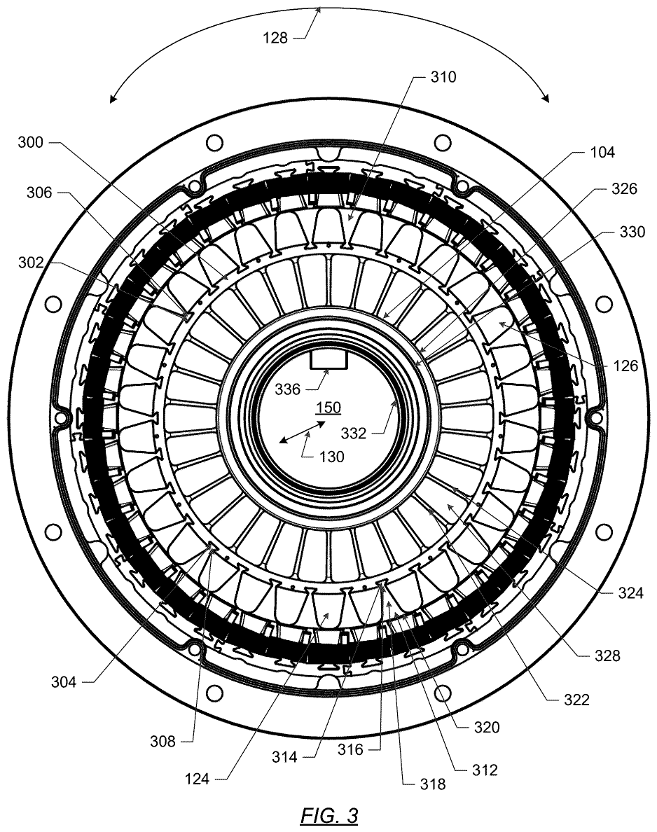

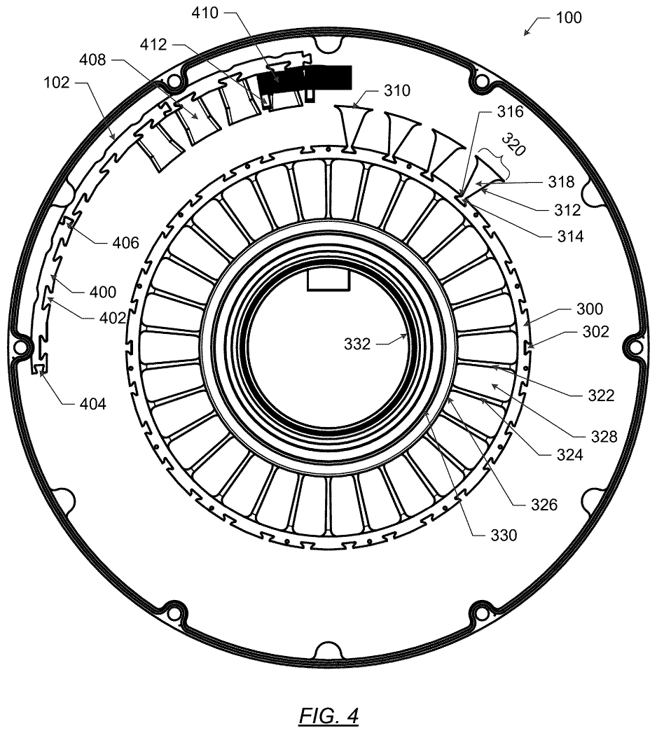

One or more embodiments provide yet further additional motor features that aid in maximizing the performance densities of a motor, as described below. Thus, attention is now turned to the figures. In particular, FIG. 1 through FIG. 7 show various views of a motor according to one or more embodiments. As used herein, the term “motor” and “electric motor” are synonymous.

FIG. 1 shows a view of various interior and exterior parts of an electric motor, in accordance of one or more embodiments. The electric motor (100) includes a stator (102) and a rotor (104). The stator (102) is a set of components that does not move relative to the electric motor (100) as a whole (i.e., from the reference frame of the motor. In other words, the stator (102) is fixed in place and does not move during operation of the electric motor (100)). In contrast, the rotor (104) is another set of components that moves relative to the electric motor (100) as a whole (i.e., from the reference frame of the motor, the rotor (104) rotates during operation of the electric motor (100)).

The stator (102) includes a stator holder (106); a number of stator teeth, such as stator tooth (108) or stator tooth (110); a number of windings, such as winding (112) or winding (114); and a number of leads, such as lead (116) or lead (118). Each of the rotor components is described in turn.

The stator holder (106) is formed from a set of stator segments (e.g., stator segment (120) or stator segment (122)). The total number of stator segments depends on the length of each stator segment and the predetermined size of the electric motor (100). However, the number of the stator segments is selected such that when the stator segments are connected together, a circular stator holder (106) is formed having a predetermined diameter.

Each stator segment is composed of a grain oriented steel (GOES) material. As explained with respect to a manufacturing method described with respect to FIG. 9, the stator segments are manufactured so that the grain of the GOES material is in a circumferential direction of each stator segment. In other words, the grain of each stator segment has a curvature similar to or the same as the overall curvature of each stator segment.

The stator segments may be formed from curved sheets that are fit together until the multiple sheets form a single object. Each of the curved sheets may be formed from a GOES material having a circumferentially oriented grain. Thus, the stator segments may be characterized as a number of stator segments composed of a number of circumferentially oriented sheets pressed together into a number of layers. Each of the circumferentially oriented sheets is composed of the grain oriented steel having the grain orientation in the circumferential direction.

A magnetic field more easily penetrates through a GOES material along the direction of the grain relative to the penetration of the same magnetic field through a GOES material in a non-grain direction. Additionally, the magnetic field may more easily penetrate through a GOES material along the direction of the grain relative to the penetration of the same magnetic field through a non-GOES material.

The magnetic field flux lines in the electric motor (100) are generated by a number of magnets in the rotor (104) (e.g., magnet (124) or magnet (126), described below). The magnetic field flux lines pass through the stator teeth and the windings, as well as through the stator segments. The shape of the magnetic flux lines is an oblong loop that is most heavily curved near the poles of the magnets and, depending on the size of the magnetic loop, may most heavily curve on an opposing end of the loop near the stator segments.

Thus, the magnetic flux lines may pass at least partially along a circumferential direction (128) when passing through the stator segments. Accordingly, the overall magnetic flux passes from one pole of the magnets (e.g., magnet (124) or magnet (126) described below), through the stator teeth (e.g., stator tooth (108) and stator tooth (120b)), through the windings (e.g., winding (112) and winding (114)), and through the stator segments (e.g., stator segment (120) and stator segment (122)), and then back through the same components to the opposing poles of the magnets.

Note that the magnetic fields may be selected to have larger or smaller magnetic flux line loops by varying the magnets to emit greater or lesser magnetic fields. Changing the size of the magnet flux line loops may change which portions of the magnetic flux lines pass through the recited components. Nevertheless, the stator segments (and other components) of the electric motor (100) are made from a GOES material, when possible, with the grain orientation in the predominate direction in which the magnetic flux lines are anticipated to be pointed with respect to such components. For example, the GOES grain may be oriented radially in the stator teeth (where the magnetic flux lines are expected to be approximately pointed in a radial direction), but the GOES grain may be oriented circumferentially in the stator segments (where the magnetic flux lines are expected to be approximately pointed in the circumferential direction). In this manner, a maximum magnetic flux may pass through the windings (e.g., winding (112) and winding (114)) for the maximum generation of electricity in the windings (when the motor is in electrical generation mode) or the maximum use of electrical energy in the windings (when the motor is in drive mode).

In more detail, for example, the stator teeth (e.g., the stator tooth (108) and the stator tooth (110)) also may be formed from a GOES material. However, because the stator teeth are pointed radially inwardly towards the center of the electric motor (100), the grain of the GOES material that forms the stator teeth may be oriented in a radial direction (e.g., radial direction (130)). However, the grain of the GOES material that forms stator segment (120) or the stator segment (122) may be oriented in the circumferential direction (128), as the selection and placement of the magnets are designed to cause the magnetic flux lines to pass approximately circumferentially through the stator segments.

Attention is now turned to the stator teeth (e.g., the stator tooth (108) or the first end (110)). The stator teeth form the structures upon which the windings (e.g., winding (112) and winding (114)) are wound. Each stator tooth is directly connected to one of the stator segments. For example, the stator tooth (108) is directly connected to the stator segment (120). Similarly, the stator tooth (110) is directly connected to stator segment (122). As indicated above, each stator tooth may be formed from a GOES material having a grain that is oriented in the radial direction (130).

Each stator tooth is connected to a corresponding stator segment via dovetail lock. For example, the stator segments are manufactured to include a number of stator teeth receiver insets (e.g., stator tooth receiver inset (132)) integrally formed as part of the stator segments. The stator teeth receiver insets are sized and dimensioned to accommodate extensions (e.g. stator tooth extension (134) that are integrally formed with and extend radially outwardly from the stator teeth. The extensions mate closely with the stator teeth receiver insets. In this manner, the stator teeth are locked in place and do not move during motor operation, in the reference frame of the motor.

Additionally, each of the stator segments (e.g., stator segment (120) and stator segment (122)) is manufactured to include a corresponding lock receiver (e.g., lock receiver (136)) at first ends of stator segments. The lock receiver is a portion of material cut away from the stator segment, and sized and dimensioned to form a dovetail lock (e.g., a triangular inset with the base of the triangle forming an inset edge of the stator segment).

Still further, each of the stator segments (e.g., stator segment (120) or stator segment (122)) is manufactured to include a corresponding lock (e.g., lock (138)) at an opposing end of the corresponding stator segment, relative to the corresponding lock receiver. Each lock may be integrally formed with the corresponding stator segment. The outer edges may be cut to fit inside the lock receivers. Thus, the locks are sized and dimensioned to fit within the lock receivers. In an embodiment, the locks and lock receivers form a dovetail lock.

Thus, each of the stator segments may include a lock receiver at one end and a lock at the other end, relative to the circumferential direction (128). Hence, each of the stator segments is connected to at least two others of the stator segments via a corresponding lock and a corresponding lock receiver. Taken together as a whole, the collection of stator segments forms the stator holder (106), which may be a circular structure surrounding the circumference of the rotor (104). In an embodiment, the stator holder (106) is the outer surface of the electric motor (100), thereby making the electric motor (100) a houseless motor in one embodiment.

As indicated above, the stator (102) also includes a number of windings (e.g., winding (112) and winding (114)). The windings are electrically conductive wires wrapped around the stator teeth. For example, one instance of windings (e.g., winding (112)) is wrapped around one stator tooth (e.g., stator tooth (108)).

The windings may be formed from a conducting material selected for a particular application (e.g., copper, gold, platinum, or other electrical conductors). In an embodiment, the windings are copper.

The wire that forms the windings may have a predetermined cross sectional shape. For example, instead of using a wire having a circular cross section, the windings may be formed from a wire having a square or rectangular cross section. In this manner, the wires may be packed more tightly together, thereby increasing electrical energy generated or electrical energy used.

Furthermore, as shown and described further with respect to FIG. 7, the windings may have a winding direction that varies within the motor. For example, the winding (114) around the stator tooth (110) may be wrapped in a clockwise direction, relative to an outwardly facing radial axis (e.g., along the radial direction (130)) of the electric motor (100). However, another set of windings (e.g., windings (140)) may be wrapped in a counter clockwise direction, relative to the outwardly facing radial axis. Changing the winding directions may be used to implement a multi-phase motor, as explained with respect to FIG. 7.

Attention is now turned to the leads (e.g., lead (116) or lead (118)). The leads may electrically connect a winding to a wire or other electrical connection that may connect to an electrical system that is external to the electric motor (100). For example, the lead (116) may connect the winding (114) to an external electrical system via an electrical wire or other electrical connection. In this manner, the leads permit electricity to flow to and from the windings of the motor.

The electric motor (100) may include additional components. For example, the stator (102) may include a jacket (142) that is connected to a ring mount (144) via one or more fasteners (e.g., fastener (146)). The jacket (142) surrounds the stator (102), but has a circumference that is greater than the stator (102) such that a cylindrical chamber (148) is formed between the external surface of the stator holder (106) and the internal surface of the jacket (142) (relative to the radial direction (130)).

In an embodiment, the cylindrical chamber (148) may be sealed at one end by the ring mount (144) and at the opposite end by a cover plate (not shown) that covers the components shown in FIG. 1. An inlet (not shown) may be placed in the cover plate, and a fluid line connected to the inlet. In an embodiment, an outlet also may be provided in the cover plate. In this manner, a fluid (e.g., water or other coolant liquid) may be pumped into the cylindrical chamber (148) via the inlet and out of the cylindrical chamber (148) via the outlet. Accordingly, the electric motor (100) may be characterized as a liquid-cooled motor in some embodiments. Note that the outlet may not be present in some embodiments, as a single inlet could be used both to pump liquid into and pump liquid out of the cylindrical chamber (148), depending on the direction of the fluid pressure gradient applied to the inlet.

Thus, the jacket cover (142) may be characterized as a jacket circumferentially disposed around and outside the stator segments, and connected a number of points to the stator segments. A liquid coolant may be disposed within a chamber inside the jacket cover (142). The liquid coolant may be in direct contact with the stator segments. In an embodiment, the electric motor (100) also may include a fluid source in liquid communication with the liquid coolant (e.g., a tank disposed on or outside the electric motor (100)). Furthermore, a pump may be in fluid communication with the fluid source and operable to pump the liquid coolant between the fluid source and the chamber within the jacket cover (142). Yet further, a cooling radiator may be in fluid communication with the fluid source. The cooling radiator may be connected to the electric motor (100) or may be separate from the 1900. The cooling radiator may permit heat in the coolant liquid to radiate into the air or yet another coolant source before the liquid coolant is returned to the source or to the chamber within the jacket cover (142).

The electric motor (100) also may include a shaft (150). The shaft (150) is connected to the rotor (104). Thus, when the shaft (150) drives the electric motor (100), then the motor generates electricity. However, when the electric motor (100) drives the shaft (150), then the electric motor (100) forces the shaft (150) to turn. The shaft (150) may be connected to some other system (e.g., the wheel of a haul truck or other vehicle) in order to drive, or be driven by, the wheel of the other system.

Attention is now turned to the rotor (104). While several of the components of the stator (102) are shown in FIG. 1, for clarity, attention is instead directed to FIG. 2 to describe the components of the rotor (104). Note that a space between the stator (102) and the rotor (104) may be referred to as an air gap.

FIG. 2 shows a different perspective of the electric motor (100) of FIG. 1. Therefore, reference numerals in FIG. 2 common to reference numerals in FIG. 1 refer to similar structures with similar descriptions. For example, for reference, FIG. 2 shows the stator holder (106), and the jacket (142) of the stator (102).

The rotor (104) includes a number of magnets (e.g., magnet (124) and magnet (126)). The magnets are connected to a rotor holder (see FIG. 3). The magnets may be placed in alternating arrangement between a number of rotor teeth (see below). Each of the magnets may be characterized as having magnetic poles. The magnetic poles are oriented in the circumferential direction (i.e., the magnets have circumferentially oriented poles) because the poles of the magnets are on opposite sides of the magnets along the circumferential direction. In this manner, magnetic flux lines are directed in the circumferential direction immediately proximate the sides of the magnets, and then curve upwardly towards the stator (102).

The magnets may have predetermined shape. In an embodiment, each of the magnets may have a frustoconical bell shape. A frustoconical bell shape may be characterized as a frustoconical structure, where the cutoff portion of the cone has curved edges. Furthermore, the bases of the frustoconical bell shapes may have a curvature that about matches the curvature of a rotor holder (see FIG. 3) to which the magnets are attached.

The magnets are disposed between a number of rotor teeth (e.g., rotor tooth (200) and rotor tooth (202), with the magnet (124) disposed therebetween). The rotor teeth may be formed from a GOES material. The grain of the GOES material may have a grain orientation in the radial direction (130) in order to maximize a magnetic flux passing through the rotor teeth.

The rotor teeth are sized and dimensioned to aid in locking the magnets in place when the magnets are subjected to centrifugal force as the rotor (104) rotates. The rotor teeth may have goblet shapes, as shown in FIG. 2 and FIG. 3. The goblet shapes may be characterized as having an outer lip extending circumferentially partially around and over the magnets to retain the magnets via pressure fits (also known as tension fits). The pressure fits are fits created by a force applied by friction or by direct force between the stator teeth and the magnets. Further detail regarding the magnets and the rotor teeth are described with respect to FIG. 3.

Note that GOES also may be used in other motor designs. For example, GOES may be used in induction motors, reluctance motors, externally excited motors, etc.

FIG. 2 also shows a ring magnet (204). The magnets and the rotor teeth also may be axially confined (i.e., held in place with respect to a longitudinal axis of the drive shaft of the electric motor (100)) by the ring magnet (204). Another ring magnet (not shown) may axially confine the magnets and rotor teeth on a side of the electric motor (100) that is longitudinally opposite the ring magnet (204) shown in FIG. 2.

FIG. 3 shows other components of the rotor (104). In FIG. 3, the ring magnet (204) shown in FIG. 2 has been removed in order to better visualize other components of the rotor (104). For example, FIG. 3 shows a rotor holder (300). The rotor holder (300) is similar in design to the stator holder (106) shown in FIG. 1, but is outwardly facing instead of inwardly facing. In an embodiment, the rotor holder (300) also may include a number of rotor holder segments locked together via locks and insets, as described with respect to FIG. 1. However, as shown in FIG. 3, the rotor holder (300) also may be formed from a single segment of material.

The material of the rotor holder (300) may be GOES material, as described with respect to FIG. 1. Thus, the grain of the GOES material also may be oriented in a circumferential direction (128).

The rotor holder (300) may be provided with a number of rotor teeth insets (e.g., rotor tooth inset (302) or rotor tooth inset (304)). Like the stator tooth receiver inset (132) of FIG. 1, the rotor teeth insets are insets cut into or molded with the rotor holder (300). The insets also may be shaped as triangles with the base of the triangle forming part of an outwardly facing outer surface of the rotor holder (300).

The rotor teeth insets are sized and dimensioned to accommodate rotor teeth locks (e.g., rotor tooth lock (306) and rotor tooth lock (308)) connected to or integrally formed with corresponding rotor teeth (e.g., rotor tooth (310) or rotor tooth (312)). The rotor teeth locks are sized and dimensioned to fit in the rotor teeth insets of the rotor holder (300). Thus, the rotor teeth may be removably, but firmly, connected to the rotor holder (300).

As can be seen in FIG. 3, the rotor teeth (e.g., rotor tooth (310) or rotor tooth (312)) may have a goblet shape. A goblet shape has a base (e.g., base (314)) that flares outwardly from a neck (e.g., neck (316)). A cup portion (e.g., cup portion (318)) also flares outwardly from the neck, but in a direction opposite of that of the base. The goblet shape also had an outer lip portion (e.g., outer lip portion (320)) that forms the top lip and top surface of the goblet shape.

While the rotor teeth (e.g., rotor teeth lock (308) or rotor tooth (310)) may be described as having a goblet shape, in an embodiment, the rotor teeth may be solid. Thus, the rotor teeth may not have an internal empty space in the cup portion or in the base, such as a drinking goblet may have. However, in other embodiments, the rotor teeth may have hollow spaces.

The outer lip portions of the rotor teeth may be sized and dimensioned to extend circumferentially at least partially over and at least partially around the rounded portion of the frustoconical bell shapes of the magnets (e.g., magnet (124) or magnet (126)). In other words, the lips of the rotor teeth circumferentially extend over at least a portion of the tops of the magnets (with “top” being in a radially outward direction). In this manner, the magnets are radially contained within the rotor (104) between the rotor teeth and the rotor holder (300) via pressure fits. Again, a pressure fit is a fitting between two components whereby the components are urged to remain together by the force applied between the two components. Accordingly, in an embodiment, the magnets may be removed when at least one stator tooth is removed from a rotor tooth inset, thereby creating space for the removal or insertion of a magnet.

The rotor holder (300) may include a number of rotor struts (e.g., rotor strut (322) and rotor strut (324)). The rotor struts provide support and resistance to compressive and expansive forces between the rotor holder (300) and an inner ring (326) of the rotor (104). The inner ring (326) is disposed radially inwardly (i.e., “within”) the rotor holder (300) and the inner ring (326) is also connected to the rotor struts). Thus, the rotor struts are connected to the inner radial side of the rotor holder and extend radially inwardly from the rotor holder (300).

In an embodiment, spaces (e.g., space (328) are disposed between the rotor struts. The spaces may be empty in some embodiments, to reduce motor weight. Some or all of the spaces may be filled with a material in other embodiments. In an embodiment, a liquid coolant also may be pumped in the spaces in order to further cool the electric motor (100).

The rotor (104) also may include one or more shaft bearings (e.g., shaft bearing (330) connected to the rotor struts or shaft bearing (332) connected to the inner ring (326) and facing the shaft (150). The shaft bearings reduce friction and control the relative motion between moving parts, namely between the rotor (104) and the shaft (150).

The electric motor (100) also may include a connection mechanism (336). The shaft (150) may be connected to the connection mechanism (336) and may be operationally disposed with respect to a shaft bearing (e.g., the shaft bearing (332) disposed radially inwardly of the outer shaft bearing (e.g., the shaft bearing (330)). The connection mechanism (336) may be a keyway slot, a spring and detent mechanism that urges the shaft (150) to remain in place, or some other connector.

FIG. 4 shows an alternative view of the electric motor (100) also shown in FIG. 1 through FIG. 3. However, in FIG. 4, many components are hidden in order to better show the relationships between certain other components. For example, the rotor holder (300), the rotor tooth inset (302), the rotor strut (322), the rotor strut (324), the inner ring (326), the space (328), the shaft bearing (330), and the shaft bearing (332) are more easily visible.

Additionally, the goblet shapes of the rotor teeth (e.g., rotor tooth (310) or rotor tooth (312)) are more visible in FIG. 4. As also shown in FIG. 3, the rotor teeth (e.g., rotor tooth (310) or rotor tooth (312)) may have a goblet shape. A goblet shape has a base (e.g., base (314)) that flares outwardly from a neck (e.g., neck (316)). A cup portion (e.g., cup portion (318)) also flares outwardly from the neck, but in a direction opposite of that of the base. The goblet shape also had an outer lip portion (e.g., outer lip portion (320)) that forms the top lip and top surface of the goblet shape.

Furthermore, the stator (102) and the stator segments (e.g., stator segment (400)) with stator tooth receiver inset (402), lock receiver (404), and lock (406) are more easily visible. The stator teeth (e.g., stator tooth (408)) are also more easily visible, as are the windings (e.g., winding (410)) and leads (e.g., lead 412)).

FIG. 5 shows another view of components of the rotor (104) and the shaft (150). Also shown for reference are the rotor holder (300), rotor tooth inset (302), the rotor strut (322), the rotor strut (324), the inner ring (326), the space (328), the shaft bearing (330), and the shaft bearing (332). Additionally, FIG. 5 shows that the shaft (150) may be provided with a shaft slot (500). The shaft slot (500) may fit with the connection mechanism (336) shown in FIG. 3 in order to connect the shaft (150) to the shaft bearing (332) (as shown in FIG. 3).

FIG. 6 shows a view of the stator (102), including the stator holder (106), the stator teeth (e.g., the stator tooth (108)), the windings (e.g., winding (112)), and the jacket (142)). FIG. 6 also shows an implementation for a multi-phase motor.

A motor winding can be broadly classified into two categories: single layer winding and double layer winding. Either category of motor winding may be implemented depending on the number of coil layers occupying a stator slot. A double layer winding has a side of two sets of coils per stator slot, whereas a single layer winding has a single coil in a stator slot. A motor of one or more embodiments may include of a double layer concentrated winding.

A motor of one or more embodiments may be, for example, a three-phase motor with 36 slots. Hence, each phase occupies 36 slots divided by the total number of phases, represented by 12 slots each. Therefore, there are 12 coil groups per stator phase.

FIG. 5 shows the coil arrangement for a three-phase motor, where the first phase is phase “A” (i.e., A1+, A1−, A2+, A1−, etc.), the first phase is phase “B” (i.e., B1+, B1−, B2+, B1−, etc.), and the first phase is phase “C” (i.e., C1+, C1−, C2+, C1−, etc.). The direction of winding of the coil around a stator tooth determines the polarity of magnetic field created when the corresponding winding carries electric current.

The alternating polarity is exploited by the 3 phase electric currents to create a rotating magnetic field. Each phase has 12 coils and 6 coil groups, as two adjacent coils form a coil group with opposite polarities of magnetic fields. The opposite polarities may be implemented by reversing the direction of coil winding on alternating stator teeth.

Thus, for example, coil A1+ and coil A1− in FIG. 6 are connected and carry the same current. However, the two coils produce an alternate pair of magnetic poles due to a difference in their winding direction.

Then follows a repeating sequence of coil sets for phase B (i.e., coils B1+ and B1−) and followed by a coil set for phase C (i.e., coils C1+ and C1−), as shown in FIG. 6. The phase sequence repeats. Thus, the phase sequence described above is followed by windings A2+ and A2− to create a pole of opposite polarity compared to windings A1+ and A1−. The pole of opposite polarity is achieved through a reverse direction of current flow compared with windings A1+and A1−. In turn, the reverse direction of current flow is achieved by the reverse direction of coil windings on windings A2+and A2−, as compared to windings A1+and A1−. The sequence is again followed by phases B and C. The winding pattern sequence may be repeated to realize the entire stator winding.

FIG. 7 shows a side view of an electric motor (700), as seen from an exterior. The electric motor (700) may be the electric motor (100) of FIG. 1 through FIG. 6. The jacket (142), the ring mount (144), and the shaft (150) remain visible.

FIG. 7 also shows the dimensions of a particular example of a motor of one or more embodiments that may be installed in a haul truck. The internal components of the electric motor (700) shown in FIG. 7 may be similar to the components shown in FIG. 1 through FIG. 6, sized and dimensioned accordingly. In the example shown in FIG. 7, an overall maximum diameter (702) (or width) of the electric motor (700) may be about 495.6 centimeters. The overall maximum length (704) of the electric motor (700) may be about 696.8 centimeters.

However, the components may be sized and dimensioned differently to fit particular engineering requirements. Thus, the dimensions described above may be increased or decreased. In other embodiments, the length of the shaft (150) may be reduced or extended to decrease or increase the overall length (704) of the electric motor (700). In still other embodiments, one or more shims or housings may be connected to some or all components of the electric motor (700) in order to increase the ease of fitting the electric motor (700) within a particular working space of a vehicle or other device that uses the electric motor (700).

Thus, one or more embodiments described herein may be characterized as a high torque density electric motor, including two major components: a stator and a rotor. Unlike a traditional electric motor where both the stator and the rotor interact through current carrying coils, called windings, the permanent magnet motor of one or more embodiments has an array of permanent magnets arranged to create a magnetic field. A permanent magnet synchronous motor is an electric machine which uses permanent magnets on the rotating part of the electric motor to generate the magnetic field.

The stator includes multiple current carrying coils which interact with the magnetic field from the permanent magnets. The coils are wound on projections along the stator inner radial circumference, often referred to as the stator teeth. The stator teeth may be formed from a soft magnetic material like electrical steel. The material provides a path for the magnetic field flux lines to interact with the magnetic field on the rotor setup by the permanent magnets.

The motor of one or more embodiments is designed to complete a magnetic circuit. The magnetic circuit involves magnetic field lines emanating from the permanent magnets, passing through stator teeth onto the stator holder (which also may be referred to as a back iron or stator yoke), and sinking to the magnet of opposite polarity through the rotor teeth. In most electrical machines, this mechanism is achieved through a single piece of electrical steel lamination or punching that creates the desired radial dimensions for the stator holder and stator teeth. However, in the motor of one or more embodiments, the stator teeth may be made by individual laminations that connect to the stator inner circumference with a tapered projection into the stator holder, often called a dovetail joint.

The motor uses a concentrated winding in the stator and permanent magnets in the rotor to setup a magnetic field. The rotor teeth project into the radial space with the help of dovetail joints in the rotor holder. The stator teeth, stator holder, and the rotor teeth are all made of soft ferromagnetic material often called electrical steel (which may include a GOES material or a non-GOES material). In the GOES material, multiple thin laminations of electrical steel may be used to realize a stator or a rotor. Use of the GOES material helps reduce the losses in the core of the motor. Additionally, the stator teeth (also known as laminations) may be insulated and welded onto each other to realize the axial length of the motor.

Electrical steel is broadly categorized into two categories: Grain Oriented Electrical Steel (GOES) and Non-Oriented Electrical Steel (NOES). The major difference being the alignment of magnetic domains in a GOES material. The GOES material has two directions of magnetization aligned perpendicular to each other; namely, a soft magnetization direction and a hard magnetization direction. The soft magnetization direction is aligned radially in a stator tooth to allow for rapid magnetization and demagnetization of the stator tooth in the radial direction. The stator holder is magnetized in the soft magnetization direction, which coincides with the circumferential direction. The stator holder and the stator teeth use GOES materials to enhance the performance of the electric motor of one or more embodiments, as described above.

The rotor occupies the radial annular space created by the stator. The rotor may use bread loaf-shaped magnets (i.e., a frustoconical bell shape or rounded frustoconical bell shape). The magnets are mounted on a rotor fixture, such as an outer ring as described above. The rotor fixture holds the magnets and the rotor teeth in place with the help of dovetail joints.

The rotor presents a yokeless design which connects via dovetail joints to a spider shaft called the rotor fixture. The rotor teeth with the rotor fixture house the permanent magnets in place, as described above. The GOES material rotor teeth hold the magnets and provide a magnetic path for magnet flux to interact with the stator. The axial length of the motor may be composed of welded GOES laminations subdivided into the rotor teeth, stator teeth, and segments of the stator holder.

The stator teeth (also known was stator laminations) are housed in a jacket. The jacket may serve as a frame which contains a liquid coolant. Thus, a motor of one or more embodiments may apply direct cooling to the stator holder and indirect cooling to the stator teeth. The direct cooling technique may allow the motor to withstand extended overload operations.

The motor of one or more embodiments may use a high pole count concentrated winding to provide maximum torque at medium motor speeds (e.g., motor speeds that are applicable to an internal combustion engine). The stator windings may use rectangular copper wire to maximize the fill factor that may generate high torque values. Fill factor is a ratio of the area consumed by electrically conductive windings in a stator slot, as compared to the total available area of the stator slot.

One or more embodiments provide for a 36 slot, 30 pole count permanent magnet synchronous motor. A permanent magnet motor is a motor that uses permanent magnets to create a magnetic field. In the present example, the motor carries three-phase electric currents in coils wound around the stator teeth. The exemplary winding arrangement is called a concentrated winding. The concentrated wound stator carries the 3 phase electric currents, which sets up a rotating magnetic field.

The rotating magnetic field interacts with magnets on the rotor and completes a magnetic circuit, as described above. When an appropriate value of current flows through the three phases, a torque is produced due to the interaction of the magnetic fields from the permanent magnets and the current carrying coils. The interaction produces the desired electromagnetic torque.

The bread loaf shaped magnets (i.e., the rounded frustoconical bell shaped magnets) may produce a near sinusoidal field in an airgap between the rotor and the stator. The unique shape helps the motor to have a reduced torque ripple and increases the efficiency of the motor.

The motor aims to produce high torque for medium speed applications. As described above, the motor makes use of GOES materials to aid in producing the higher torque, as described above. GOES materials have superior alignment of magnetic domains in a single direction, often known as the soft magnetization direction. The soft magnetization direction of a GOES material allows the magnetic flux to flow through the stator teeth magnetic circuit with lower core losses.

As indicated above, the magnetic flux is analogous to current in an electrical circuit. The density of magnetic flux represents the strength of the magnetic field at the point under consideration. Using a GOES material for the stator holder (and other components) also allows the stator teeth and yoke to operate in a linear B-H curve region, instead of entering the saturation region.

A B-H curve captures the relationship between the magnetic flux density in the electrical steel that can be obtained by magnetizing the core with the help of current carrying coils. The coils refer to the coils around the stator teeth. Since higher values of magnetic flux density can be achieved in the stator core and the airgap, higher performance can be expected out of the same volume under the same conditions of current and magnetic strength. Higher performance includes higher value of electromagnetic torque and lower losses in the core, relative to other motors.

High torque in a small packaging volume is further improved by the direct cooling technique described above, which allows the liquid to extract heat from the stator laminations, and thereby increase motor cooling efficiency. Liquid cooling also allows the motor to have extended overload durations. The low packaging volume is also realized with the help of segmenting the stator, segmenting the rotor, or both. The segments may be joined with the help of tapered mechanical joints often referred to as dovetail joints. The rotor teeth are also held in place on the outer circumference of a rotor holder (outer ring) with the help of dovetail joints.

While FIG. 1 through FIG. 7 show a configuration of components, other configurations may be used without departing from the scope of the one or more embodiments. For example, various components may be combined to create a single component. As another example, the functionality performed by a single component may be performed by two or more components.

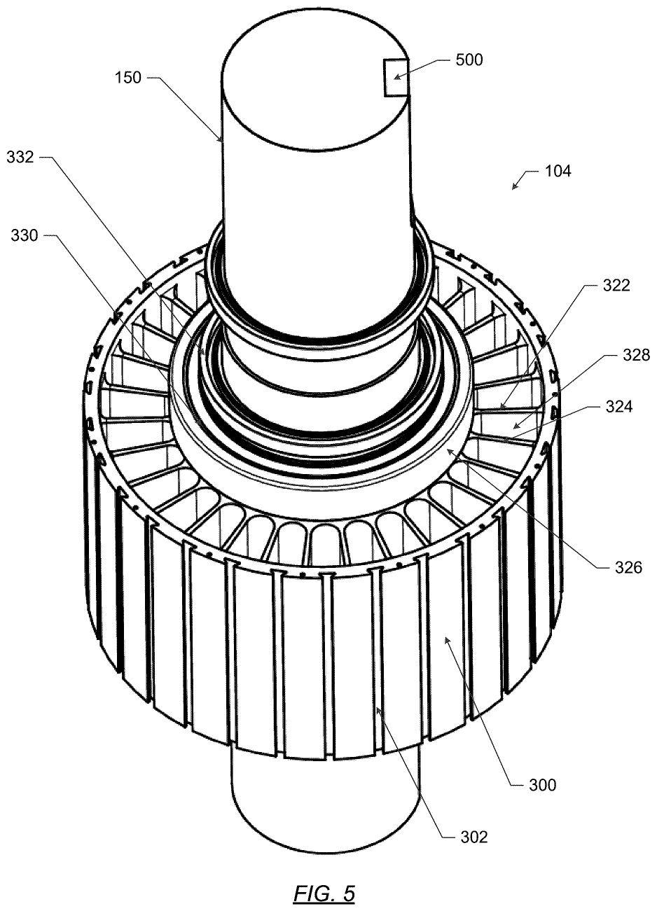

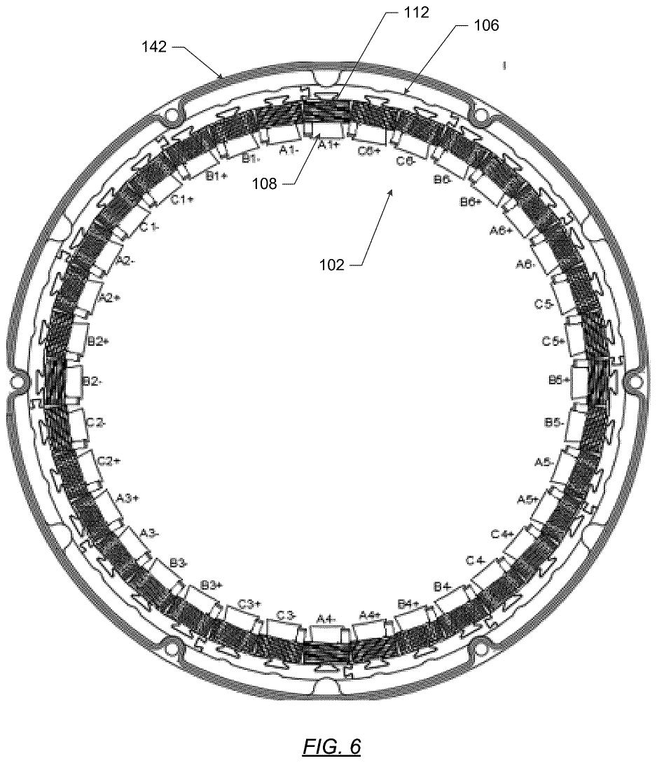

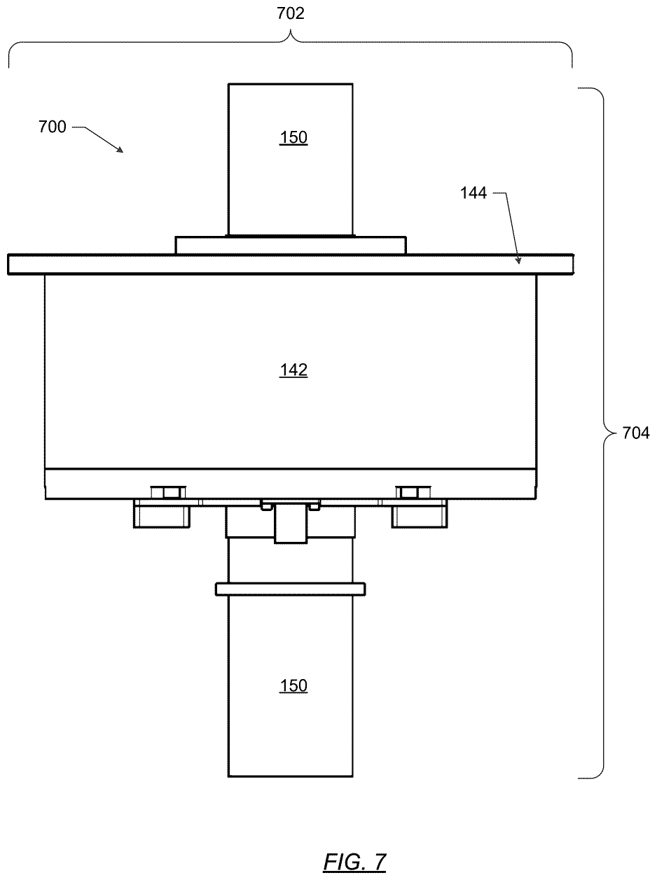

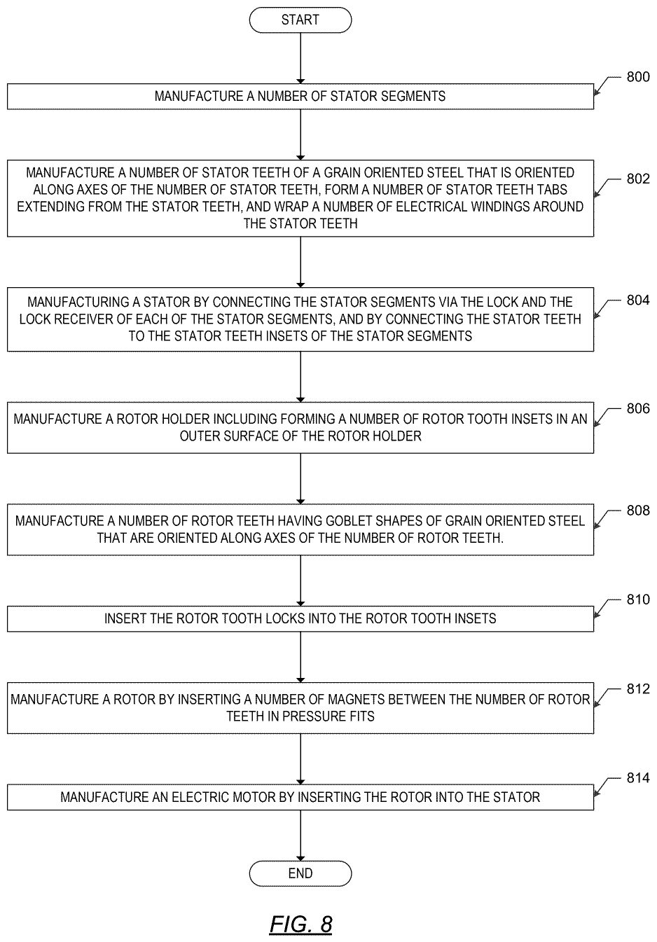

FIG. 8 shows an example of manufacturing an electric motor, in accordance with one or more embodiments. The following example is for explanatory purposes and not intended to limit the scope of the one or more embodiments.

Step 800 includes manufacturing a number of stator segments. Manufacturing each of the stator segments includes a subprocess. The subprocess includes pressing a number of sheets into a block. Each of the sheets is made of a grain oriented steel. The subprocess also includes removing a portion of the grain oriented steel to shape the block into an arc of a circle. The arc includes a stator segment among the stator segments. The subprocess also includes forming a lock in a first end of the arc of the stator segment. The lock may be formed by removing material from the block or by connecting the lock to the stator segment. The subprocess also includes forming a lock receiver at a second end of the arc of the stator segment, opposite the first end. The lock receiver may be formed by removing material from the stator segment. The subprocess also includes forming a number of stator teeth insets on an interior surface of the arc of the stator segment.

Step 802 includes manufacturing a number of stator teeth of the grain oriented steel that are oriented along the axes of the stator teeth. Manufacturing the stator teeth forms a number of stator tooth extensions extending from the stator teeth. Additionally, a number of electrical windings are wound around the stator teeth. The method also may include wrapping the electrical windings around the stator teeth by alternating winding directions for alternating ones of the stator teeth in the circumferential direction.

Step 804 includes manufacturing a stator by connecting the number of stator segments via the lock and the lock receiver of each of the number of stator segments, and by connecting the number of stator teeth to the number of stator teeth insets of the number of stator segments. So connecting the stator segments to each other may form dovetail joints. So connecting the stator teeth to the stator teeth insets also may form dovetail joints.

In an embodiment, the method of FIG. 8 may terminate after step 804. For example, the prepared stator may be transferred to another manufacturing process that adds a rotor to the stator in order to manufacture a complete electric motor. However, the method of FIG. 8 also may be extended to form a complete electric motor.

Thus, step 806 includes manufacturing a rotor holder, including forming a number of rotor tooth insets in an outer surface of the rotor holder. Formation of the rotor holder may be performed in a manner similar to step 802 by manufacturing rotor holder segments. However, the segments have a greater curvature so that the rotor holder has a desired diameter which is at least smaller than a diameter of the stator. In another embodiment, the rotor holder may be formed as a single segment. In either case, the rotor teeth insets may be formed by removing material from the rotor holder.

Step 808 includes manufacturing a number of rotor teeth having goblet shapes of grain oriented steel that are oriented along the axes of the rotor teeth. The goblet shapes have outer lips extending circumferentially from the axes of the rotor teeth. The goblet shapes also include bases that form and rotor tooth locks disposed opposite the outer lips.

Step 810 includes inserting the rotor tooth locks into the rotor tooth insets. For example, the rotor tooth locks may be slid into the rotor along a longitudinal axis of the rotor.

Step 812 includes manufacturing the rotor by inserting a number of magnets between the number of rotor teeth in pressure fits. The magnets including circumferentially oriented poles. The polarities of the magnets may alternate between the rotor teeth. The magnets may be frustoconical bell shapes having bell bottoms in contact with the rotor holder.

Step 814 includes manufacturing the electric motor by inserting the rotor into the stator. Inserting the rotor may include securing a relative position of the rotor and the stator by connecting a ring to the stator segments and to the rotor holder. If desired, a jacket or a retaining ring may be used to retain the rotor within the stator and to surround the rotor holder.

Furthermore a shaft may be operably disposed through the rotor and the stator. The shaft may be connected to the rotor via a key slot or other connector, as shown with respect to FIG. 1 through FIG. 7.

In an embodiment, the rotor may be inserted into the stator such that an air gap is established between the stator teeth in the stator and the magnets and the rotor teeth in the rotor. The air gap may be narrow (on the order of about a millimeter), or may be broader, depending on an expected shape of the flux lines emanating from the magnets, in order to maximize the amount of flux lines passing along the grain of GOES materials in the rotor holder, rotor teeth, stator teeth, and stator holder.

In an embodiment, the method of FIG. 8 also may include manufacturing a jacket. In this case, the method may include connecting the jacket to the stator segments to form at least one chamber defined between outer surfaces of the stator segments and the jacket. The method also may include connecting at least one chamber to a fluid source, connecting a pump to the fluid source, and placing a liquid coolant within the fluid source. The method also may include pumping the liquid coolant into the chamber or chambers such that the liquid coolant is in direct contact with the stator segments.

The method also may include manufacturing a number of rotor holder segments. Then, the method may include connecting the rotor holder segments to manufacture the rotor holder. The connections may be performed by connecting the locks of the rotor holder segments to the insets of other rotor holder segments.

The method also may include manufacturing an inner rotor ring. In this case, the method also may include placing the inner rotor ring inside the rotor holder and connecting an inner surface of the rotor holder to the inner rotor ring via a number of rotor struts. Additionally, a keyway may be formed in the inner rotor ring. A shaft bearing may be connected to the inner rotor ring. A shaft may be inserted through the inner rotor ring against the shaft bearing. Then, the shaft may be connected to the keyway.

In an embodiment, the method may include additional steps in order to manufacture a three-phase electric motor. The additional steps may include manufacturing the stator teeth by manufacturing 36 stator teeth arranged in groups of three stator teeth on each one of the stator segments. However, the number of stator teeth may be varied. For example, a three-phase motor may be formed using 72 stator teeth or 18 stator teeth. The number of phases may be varied as well by arranging the windings into one or two phases or more than three phases.

The additional steps also may include inserting the rotor into the stator to form the three-phase electric motor having 12 electrical winding groups per stator phase. The additional steps also may include connecting a ring magnet to the rotor. The result is a three-phase electric motor having properties and components as described with respect to FIG. 1 through FIG. 7, and particularly with respect to FIG. 7.

The term “about,” when used with respect to a physical property that may be measured, refers to an engineering tolerance anticipated or determined by an engineer or manufacturing technician of ordinary skill in the art. The exact quantified degree of an engineering tolerance depends on the product being produced and the technical property being measured. For example, two angles may be “about congruent” if the values of the two angles are within a first predetermined range of angles for one embodiment, but also may be “about congruent” if the values of the two angles are within a second predetermined range of angles for another embodiment. The ordinary artisan is capable of assessing what is an acceptable engineering tolerance for a particular product, and thus is capable of assessing how to determine the variance of measurement contemplated by the term “about.”

As used herein, the term “connected to” contemplates at least two meanings, unless stated otherwise. In a first meaning, “connected to” means that component A was, at least at some point, separate from component B, but then was later joined to component B in either a fixed or a removably attached arrangement. In a second meaning, “connected to” means that component A could have been integrally formed with component B. Thus, for example, a bottom of a pan is “connected to” a wall of the pan. The term “connected to” may be interpreted as the bottom and the wall being separate components that are snapped together, welded, or are otherwise fixedly or removably attached to each other. However, the bottom and the wall may be deemed “connected” when formed contiguously together as a monocoque body.

In addition, the term “directly connected to” means that component A and component B are connected immediately adjacent to each other. For example, component A and component B may share a common point of contact in at least one area of both components. However, the common point of contact may be a connector (e.g., a bolt, a screw, etc.), in which case it is possible that component A is “directly connected to” component B without a direct contact between the surfaces of component A and component B. However, in any case, if component A and component B are “directly connected to” each other, then no intervening parts, other than possibly a connector, exist between component A and component B.

The figures show diagrams of embodiments that are in accordance with the disclosure. The embodiments of the figures may be combined and may include or be included within the features and embodiments described in the other figures of the application. The features and elements of the figures are, individually and as a combination, improvements to the technology of electric motors. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, the word “or” is an “inclusive or” and, as such includes “and.” Further, items joined by an or may include any combination of the items with any number of each item unless expressly stated otherwise.

In the above description, numerous specific details are set forth in order to provide a more thorough understanding of the one or more embodiments. However, it will be apparent to one of ordinary skill in the art that the one or more embodiments may be practiced without these specific details. In other instances, well-known features have not been described in detail to avoid unnecessarily complicating the description. Further, other embodiments not explicitly described above can be devised which do not depart from the scope of the one or more embodiments as disclosed herein. Accordingly, the scope of the one or more embodiments should be limited by the attached claims.

1. A method of manufacturing, comprising:
manufacturing a plurality of stator segments, wherein manufacturing each of the plurality of stator segments comprises a subprocess comprising:
pressing a plurality of sheets into a block, wherein each of the plurality of sheets comprises a grain oriented steel,
removing a portion of the grain oriented steel to shape the block into an arc of a circle, wherein the arc comprises a stator segment among the plurality of stator segments,
forming a lock in a first end of the arc of the stator segment,
forming a lock receiver at a second end of the arc of the stator segment, opposite the first end, and
forming a plurality of stator teeth insets on an interior surface of the arc of the stator segment;
manufacturing a plurality of stator teeth of the grain oriented steel that are oriented along axes of the plurality of stator teeth, forming a plurality of stator tooth extensions extending from the plurality of stator teeth, and wrapping a plurality of electrical windings around the plurality of stator teeth; and
manufacturing a stator by connecting the plurality of stator segments via the lock and the lock receiver of each of the plurality of stator segments, and by connecting the plurality of stator teeth to the plurality of stator teeth insets of the plurality of stator segments.

2. The method of claim 1, further comprising:
manufacturing a rotor holder including forming a plurality of rotor tooth insets in an outer surface of the rotor holder;
manufacturing a plurality of rotor teeth comprising goblet shapes of grain oriented steel that are oriented along axes of the plurality of rotor teeth, wherein the goblet shapes have outer lips extending circumferentially from the axes of the plurality of rotor teeth and rotor tooth locks disposed opposite the outer lips;
inserting the rotor tooth locks into the rotor tooth insets; and
manufacturing a rotor by inserting a plurality of magnets between the plurality of rotor teeth in pressure fits, the plurality of magnets comprising circumferentially oriented poles.

3. The method of claim 2, wherein polarities of the plurality of magnets alternate between the plurality of rotor teeth.

4. The method of claim 2, wherein the plurality of magnets comprises frustoconical bell shapes having bell bottoms in contact with the rotor holder.

5. The method of claim 2, further comprising manufacturing an electric motor by inserting the rotor into the stator.

6. The method of claim 5, wherein the rotor is inserted into the stator such that an air gap is established between the plurality of stator teeth in the stator and the plurality of magnets and the plurality of rotor teeth in the rotor.

7. The method of claim 5, further comprising:
securing a relative position of the rotor and the stator by connecting a ring to the plurality of stator segments and to the rotor holder.

8. The method of claim 5, further comprising:
manufacturing a jacket; and
connecting the jacket to the plurality of stator segments to form at least one chamber defined between outer surfaces of the plurality of stator segments and the jacket.

9. The method of claim 8, further comprising:
connecting at least one chamber to a fluid source;
connecting a pump to the fluid source; and
placing a liquid coolant within the fluid source.

10. The method of claim 9, further comprising:
pumping the liquid coolant into the at least one chamber such that the liquid coolant is in direct contact with the plurality of stator segments.

11. The method of claim 2, further comprising:
manufacturing a plurality of rotor holder segments;
connecting the plurality of rotor holder segments to manufacture the rotor holder;
manufacturing an inner rotor ring;
placing the inner rotor ring inside the rotor holder;
connecting an inner surface of the rotor holder to the inner rotor ring via a plurality of rotor struts, wherein spaces are disposed between the plurality of rotor struts; and
pumping a liquid coolant in the spaces.

12. The method of claim 11, further comprising:
forming a keyway in the inner rotor ring.

13. The method of claim 12, further comprising:
connecting a shaft bearing to the inner rotor ring.

14. The method of claim 13, further comprising:
inserting a shaft through the inner rotor ring against the shaft bearing; and
connecting the shaft to the keyway.

15. The method of claim 1, wherein connecting the lock into the first end of the arc of the stator segment to the lock receiver of the arc of another stator segment in the plurality of stator segments forms a dovetail joint.

16. The method of claim 1, wherein connecting the plurality of stator tooth extensions on the plurality of stator teeth to the plurality of stator teeth insets on the interior surface of the arc of the stator segment forms a plurality of dovetail joints.

17. The method of claim 2, wherein connecting the plurality of rotor tooth locks of the plurality of rotor teeth into the plurality of rotor tooth insets of the rotor holder forms a plurality of dovetail joints.

18. The method of claim 1, further comprising:
wrapping the plurality of electrical windings around the plurality of stator teeth by alternating winding directions for alternating ones of the plurality of stator teeth in a circumferential direction.

19. The method of claim 2, further comprising manufacturing a three-phase electric motor by:
manufacturing the plurality of stator teeth by manufacturing thirty-six stator teeth arranged in groups of three stator teeth on each one of the plurality of stator segments; and
inserting the rotor into the stator to form the three-phase electric motor having twelve electrical winding groups per stator phase.

20. The method of claim 2, further comprising:
connecting a ring magnet to the rotor.
